(19) United States
(12) Patent Application Publication
(10) Pub. No.: US 2026/0273707 A1
(43) Pub. Date: Sep. 17, 2026

(54) BLIND RIVET NUT-SETTING TOOL

(71) Applicant: MILWAUKEE ELECTRIC TOOL CORPORATION, Brookfield, WI (US)

(72) Inventor: Blaine Vollmer, Plover, WI (US)

(21) Appl. No.: 19/682,565

(22) Filed: May 20, 2026

Related U.S. Application Data
(62) Division of application No. 18/982,795, filed on Dec. 16, 2024, now Pat. No. 12,734,657.
Application No. 18/982,795 is a division of application No. 18/142,782, filed on May 3, 2023, now Pat. No. 12,194,603.
Application No. 18/142,782 is a continuation of application No. 16/558,715, filed on Sep. 3, 2019, now Pat. No. 11,673,243.
(60) Provisional application No. 62/727,160, filed on Sep. 5, 2018.

(51) Int. Cl. B25B 27/00; B21J 15/10; B21J 15/26; F16B 37/06

(52) U.S. Cl. CPC B25B 27/0014; B21J 15/105; B21J 15/26; F16B 37/067; Y10T 29/5377

(57) ABSTRACT

A method of operating a blind rivet nut-setting tool includes pressing a blind rivet nut on an output shaft against a workpiece to move the output shaft from a first position to a second position and actuate a limit switch, which automatically activates a first motor to rotate the output shaft and thread the blind rivet nut onto the shaft. A trigger is then depressed to activate a second motor, which rotates a cam member and displaces the output shaft to plastically deform and permanently set the blind rivet nut on the workpiece. A reverse trigger is subsequently depressed to activate the first motor in an opposite direction and unthread the blind rivet nut from the output shaft.

### CROSS-REFERENCE TO RELATED APPLICATIONS

This application is a divisional of co-pending U.S. Patent Application No. 18/982,795, filed on December 16, 2024, which is a divisional of U.S. Patent Application No. 18/142,782, filed on May 3, 2023, now U.S. Patent No. 12,194,603, which is a continuation of U.S. Patent Application No. 16/558,715, filed on September 3, 2019, now U.S. Patent No. 11,673,243, which claims priority to U.S. Provisional Patent Application No. 62/727,160, filed on September 5, 2018, the entire contents of all of which are incorporated herein by reference.

### FIELD OF THE INVENTION

The present invention relates to blind rivet nut-setting tools, and more particularly to powered blind rivet nut-setting tools.

### BACKGROUND OF THE INVENTION

Powered blind rivet nut-setting tools rotate an output shaft to thread the output shaft into a blind rivet nut. After the output shaft is threaded into the blind rivet nut, the output shaft performs a setting stroke to set the blind rivet nut on a workpiece.

### SUMMARY OF THE INVENTION

The present disclosure provides, in one aspect, a method of operating a blind rivet nut-setting tool, the method including: activating a first motor automatically in response to pressing a blind rivet nut coupled to an output shaft of the tool against a workpiece, thereby displacing the output shaft along a longitudinal axis from a first position, in which a limit switch is not engaged, to a second position, in which the limit switch is engaged, causing the first motor and the output shaft to rotate about the longitudinal axis relative to the blind rivet nut; depressing a trigger to activate a second motor, causing the second motor and a cam member to rotate about a rotational axis and displace the output shaft along the longitudinal axis to a third position where the blind rivet nut becomes plastically deformed and permanently set on the workpiece; and depressing a reverse trigger to activate the first motor and rotate the output shaft in an unthreading direction to unthread the blind rivet nut from the output shaft.

The present disclosure provides, in another aspect, a method of operating a blind rivet nut-setting tool, the method including: engaging a blind rivet nut with an output shaft of the tool with a sufficient force, causing the output shaft to move the output shaft in a rearward direction along a longitudinal axis from a first position to a second position; activating a first motor to rotate the output shaft about the longitudinal axis in response to the output shaft reaching the second position, thereby coupling the blind rivet nut onto the output shaft and translating the output shaft toward the first position; deactivating the first motor in response to the output shaft returning to the first position, at which point the blind rivet nut is engaged with a nosepiece of the tool; and activating a second motor to translate the output shaft along the longitudinal axis toward a third position that is rearward of the first position, thereby crushing the blind rivet nut against the nosepiece.

Other features and aspects of the invention will become apparent by consideration of the following detailed description and accompanying drawings.

### BRIEF DESCRIPTION OF THE DRAWINGS

FIG. 1 is a perspective view of a blind rivet nut-setting tool.

FIG. 2 is a cross-sectional view of the blind rivet nut-setting tool of FIG. 1.

FIG. 3 is an enlarged cross-sectional view of the blind rivet nut-setting tool of FIG. 1.

FIG. 4 is an enlarged perspective view of the blind rivet nut-setting tool of FIG. 1, with portions removed.

FIG. 5 is a cross-sectional view of an output shaft of the blind rivet nut-setting tool of FIG. 1 with a blind rivet nut partially threaded onto the output shaft, and the blind rivet nut inserted through an aperture in a workpiece.

FIG. 6 is a cross-sectional view of the output shaft of the blind rivet nut-setting tool of FIG. 1 translated in a rearward direction to initiate a threading action of the output shaft into the blind rivet nut.

FIG. 7 is a cross-sectional view of the output shaft of the blind rivet nut-setting tool of FIG. 1 being threaded into the blind rivet nut.

FIG. 8 is a cross-sectional view of the output shaft of the blind rivet nut-setting tool of FIG. 1 being further threaded into the blind rivet nut after the blind rivet nut has reached a nosepiece of the blind rivet nut-setting tool.

FIG. 9 is a cross-sectional view of the output shaft of the blind rivet nut-setting tool of FIG. 1 performing a setting stroke on the blind rivet nut.

FIG. 10 is a cross-sectional view of the output shaft of the blind rivet nut-setting tool of FIG. 1 being unthreaded from the blind rivet nut.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

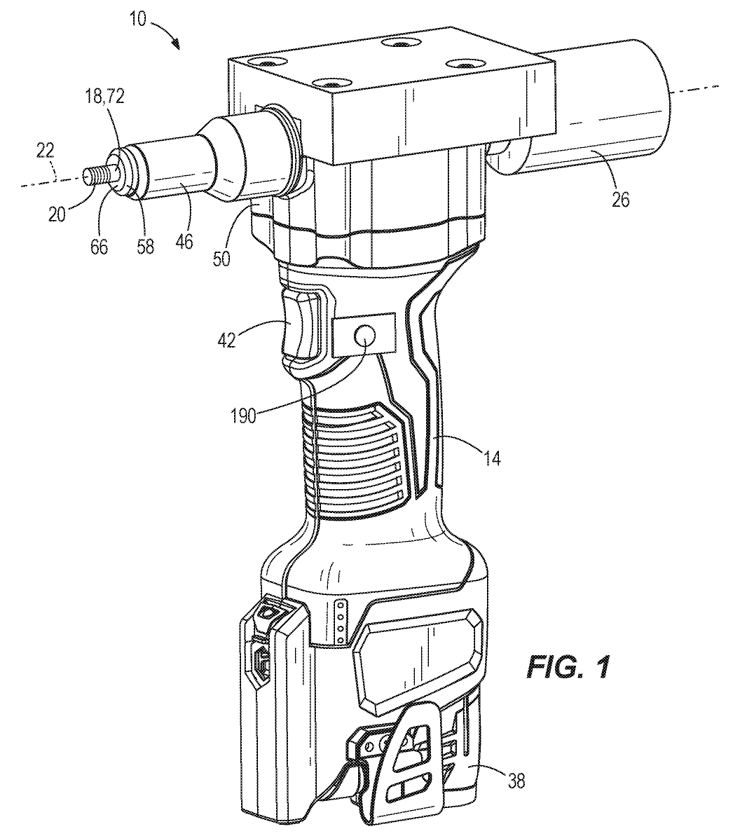

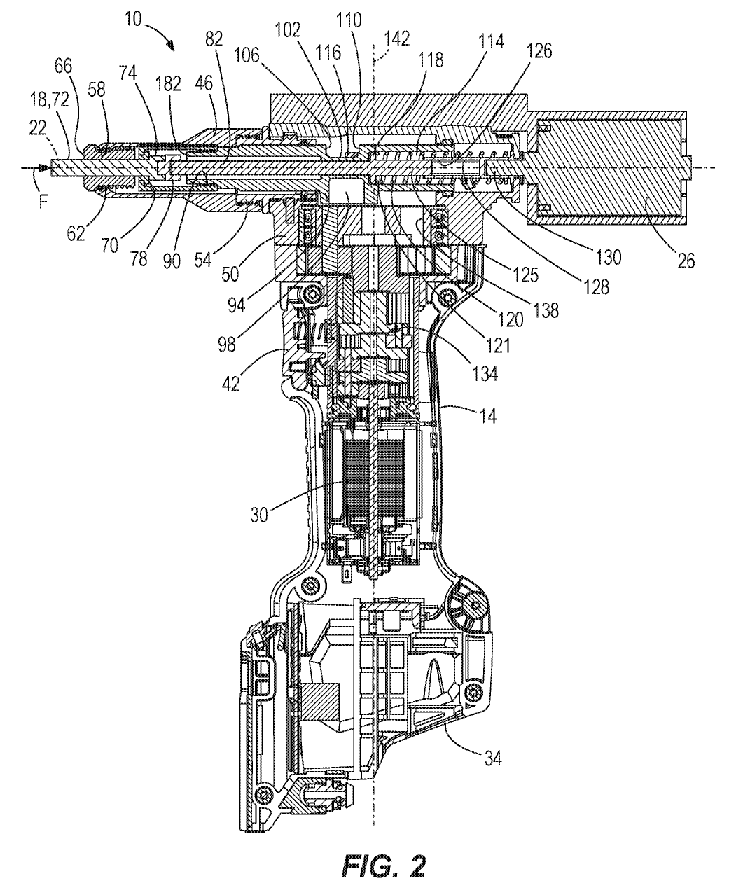

As shown in FIGS. 1 and 2, a blind rivet nut-setting tool 10 includes a housing 14, an output shaft 18 having threads 20 and defining a longitudinal axis 22, a first motor 26 for rotating the output shaft 18 about the longitudinal axis 22, and a second motor 30 for translating the output shaft 18 along the longitudinal axis 22. The housing 14 includes a battery receptacle 34 FIG. 2 for receiving a battery 38 FIG. 1 to power the first and second motors 26, 30 and a trigger 42 for activating the second motor 30 to initiate a setting stroke, as explained in further detail below.

With reference to FIG. 2, the housing 14 includes a front piece 46 that is threaded onto a main body 50 of the housing 14 via threads 54. A nosepiece 58 is threaded into the front piece 46 via threads 62. The output shaft 18 extends through the nosepiece 58 and into a tube 70. The output shaft 18 is a multi-piece output shaft including a working end 72 having the threads 20 and a shoulder 74 within the tube 70, a first piece78 within the tube 70, and a second piece 82 that extends into the tube 70 and through a carrier 86 that is arranged along the longitudinal axis 22. In alternative embodiments, the output shaft 18 is integrally formed along its entire length. The tube 70 is threaded to the carrier 86 via threads 90.

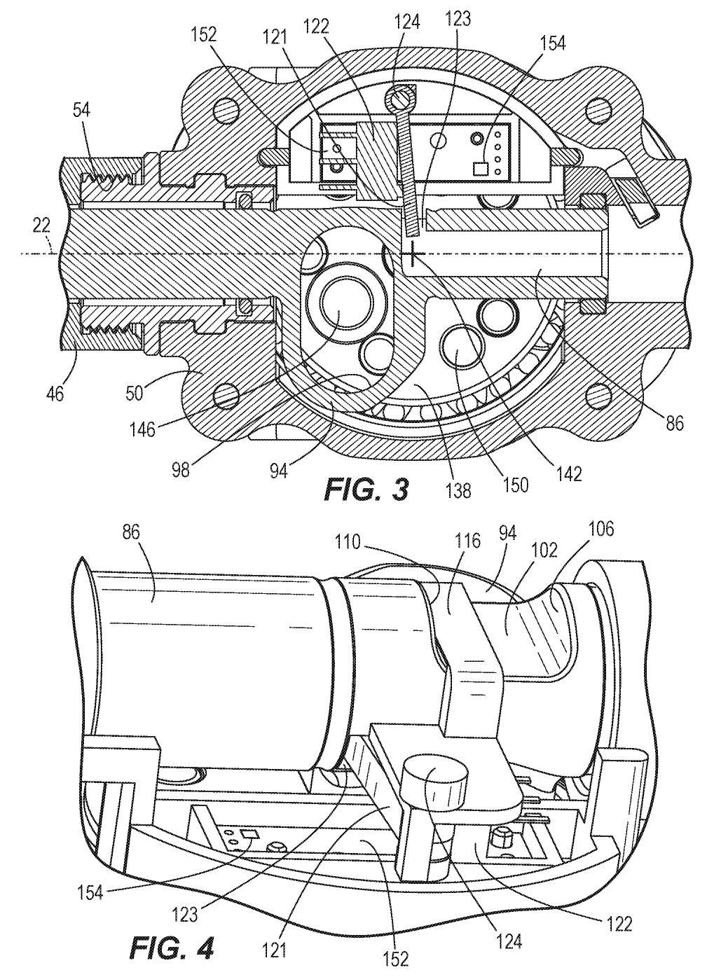

With reference to FIGS. 2 and 3, the carrier 86 includes a lobe 94 with a recess 98, a groove 102 defined by first and second shoulders 106, 110 and a bore 114. A bracket 116 is arranged in the groove 102. The second piece 82 of the output shaft 18 includes a flange 118 arranged in the bore 114. The flange 118 is biased by a compression spring 120 towards the carrier 86, such that the carrier 86 is biased toward the nosepiece 58. As shown in FIGS. 2-4, an actuating arm 121 of a limit switch 122 extends through a groove 123 in the carrier 86 into the bore 114 of the carrier 86 and is arranged on a side of the flange 118 of the second piece 82 opposite the bracket 116. The bracket 116 supports the limit switch 122, and the actuating arm 121 is pivotably coupled to the bracket 116 via a pivot 124 (e.g., a fastener), allowing the actuating arm 121 to pivot between a neutral position, in which the limit switch is not actuated, and an actuating position, in which the limit switch 122 is actuated.

An end 125 of the second piece 82 of the output shaft 18 extends into a recess 126 of a drive shaft 128, which is coupled for rotation with an output shaft 130 of the first motor 26. The recess 126 of the drive shaft 128 has a non-circular cross-sectional shape, and the end 125 of the second piece 82 of the output shaft 18 has a corresponding non-circular cross-sectional shape, such that the second piece 82 of the output shaft 18 is coupled for co-rotation with the drive shaft 128. In alternative embodiments, the end 125 of the second piece 82 of the output shaft 18 has a spline fit within the recess 126 of the drive shaft 128.

When the tool 10 is not operating, the compression spring 120, via the flange 118 of the second piece 82, biases the output shaft 18 to a neutral, first output shaft position shown in FIG. 2. Likewise, the carrier 86 is biased by the compression spring 120, via the flange 118 of the second piece 82, to a neutral first carrier position, also shown in FIG. 2. When the carrier 86 is in the first carrier position, the second shoulder 110 abuts against the bracket 116.

With reference to FIGS. 2 and 3, the second motor 30 transmits torque through a multi-stage planetary transmission 134 terminating in a cam member 138 that defines a rotational axis 142 that intersects and is perpendicular to the longitudinal axis 22. The cam member 138 includes a pin 146 that is eccentrically arranged on the cam member 138 and extends into the recess 98 of the lobe 94 of the carrier 86. With reference to FIG. 3, the cam member 138 includes a magnet 150, and a printed circuit board (PCB) 152 in the main body 50 of the housing 14 includes a sensor 154, such as a Hall-effect sensor, that is configured to detect the proximity of the magnet 150 as the cam member 138 rotates relative to the PCB 152. In other embodiments, the magnet 150 can be located on the carrier 86, such that the sensor 154 can detect proximity of the magnet as the carrier 86 translates relative to the PCB 152.

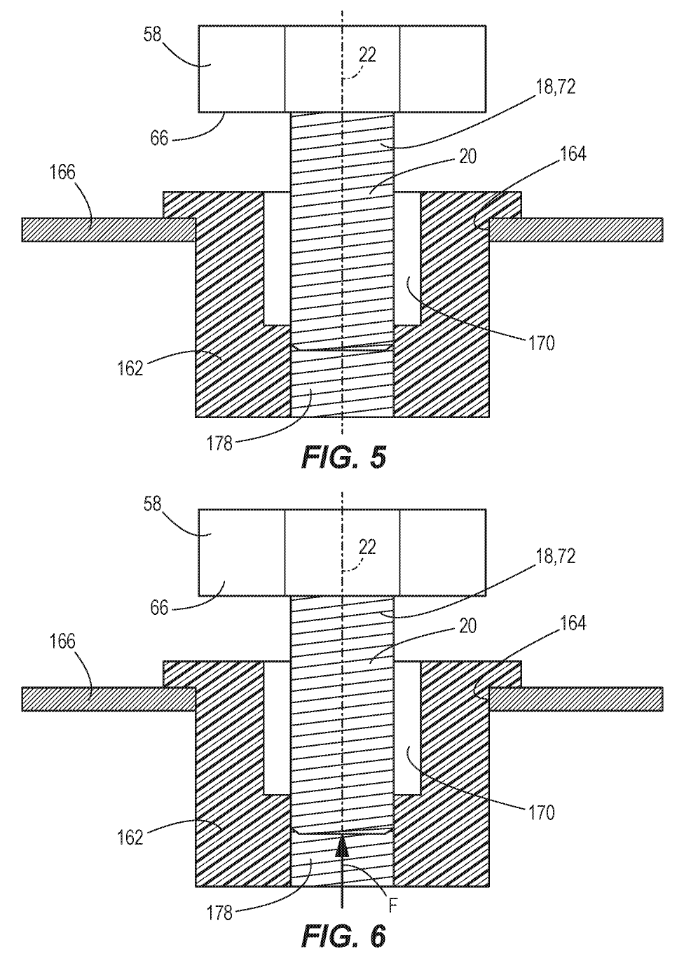

In operation, an operator uses the tool 10 to set a blind rivet nut 162 into an aperture 164 in a workpiece 166, as shown in FIG. 5. First, the operator manually threads the blind rivet nut 162 partially onto the working end 72 of the output shaft 18. Specifically, the operator places the working end 72 of the output shaft 18 into an unthreaded bore 170 of the blind rivet nut 162, and then manually partially threads a threaded bore 178 of the blind rivet nut 162 onto the threads 20 of the working end 72 as shown in FIG. 5.

The operator then inserts the blind rivet nut 162 into the opening 164 in the workpiece 166 and pushes the tool 10 toward the workpiece 166. As shown in FIG. 6, this results in a normal force F being applied to the output shaft 18 in a rearward direction toward the first motor 26, causing the output shaft 18 to translate in the rearward direction along the longitudinal axis 22, relative to the nosepiece 58 and carrier 86. Rearward translation of the output shaft 18 also pivots the actuating arm 121 (via the interaction between the flange 118 and the arm 121) away from the switch 122, from the neutral position to the actuating position. In the actuating position, the arm 121 actuates the limit switch 122, coinciding with the output shaft 18 reaching the second output shaft position.

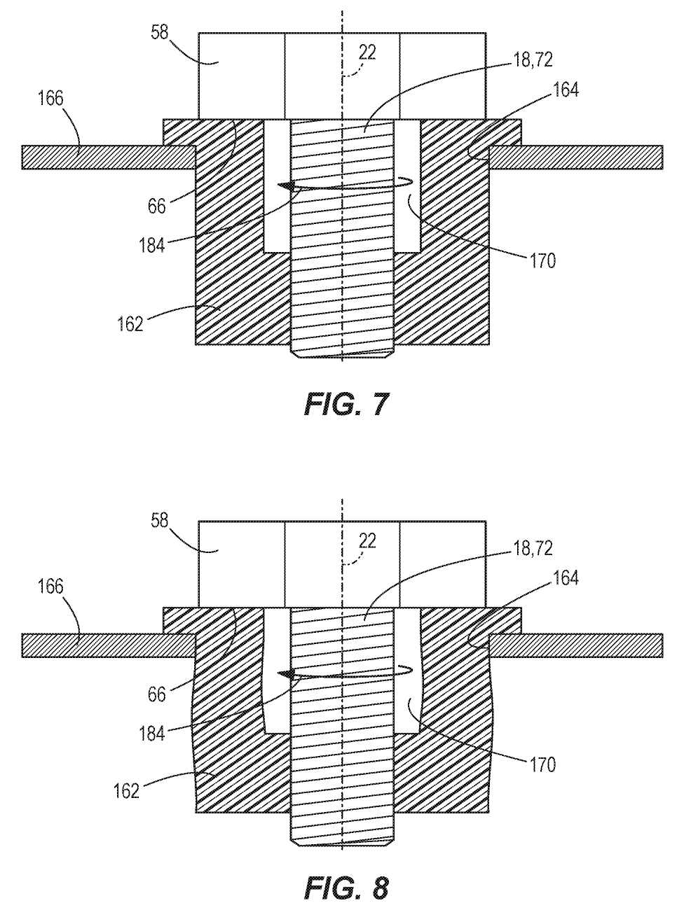

In response to the limit switch 122 being actuated when the output shaft 18 has reached the second output shaft position, the first motor 26 rotates the output shaft 130 in a threading direction, which causes corresponding rotation of the drive shaft 128 and the output shaft 18, thus beginning a threading action into the blind rivet nut 162. Specifically, as the operator continues to push the working end 72 of the output shaft 18 toward the blind rivet nut 162, the output shaft 18 rotates in a threading direction 184 FIG. 7, causing the working end 72 of the output shaft 18 to be threaded into the threaded bore 178 of the blind rivet nut 162. As the output shaft 18 threads into the threaded bore 178, the blind rivet nut 162 translates along the output shaft 18 until it abuts against the end 66 of the nosepiece 58 as shown in FIG. 7. However, the output shaft 18 continues rotating in the first direction 184 as shown in FIG. 8, thereby continuing to thread its way through the threaded bore 178 of the blind rivet nut 162. Thus, the output shaft 18 rotates about and translates along the longitudinal axis 22 away from the second output shaft position and towards the first output shaft position until the actuating arm 121 has returned to its neutral position in which the limit switch 122 is de-actuated. Once the limit switch 122 is de-actuated, the first motor 26 is deactivated, thereby ceasing rotation of the output shaft 18, which is now fully threaded into the blind rivet nut 162.

After the blind rivet nut 162 is fully threaded onto the output shaft 18, the operator may initiate a setting stroke by pulling the trigger 42 to activate the second motor 30. The second motor 30 rotates the cam member 138 counterclockwise as viewed in FIG. 3 about the rotation axis 142 via the transmission 134, causing the pin 146 to move within the recess 98 of the lobe 94 and thereby pull the lobe 94 away from the front piece 46.

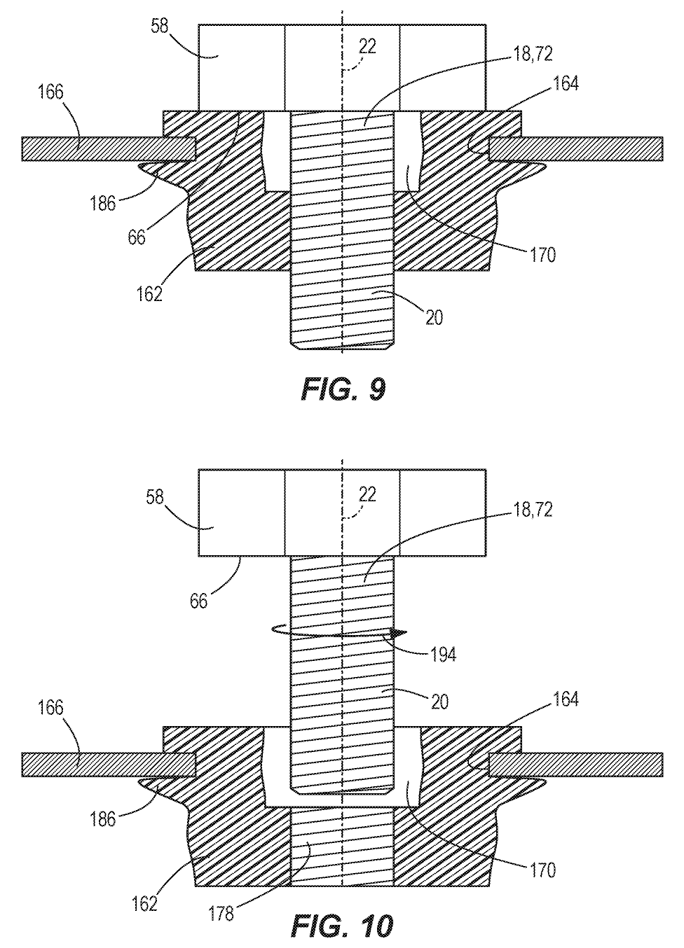

As the lobe 94 is pulled away from the front piece 46, the carrier 86 translates along the longitudinal axis 22 from the first carrier position to a second carrier position, thereby pulling the output shaft 18 (via the flange 118) along the longitudinal axis 22 from the first output shaft position (or a position near the first output shaft position) to a third output shaft position corresponding to the second carrier position of the carrier 86. During the setting stroke, the output shaft 18 sets the blind rivet nut 162 by deforming a portion 186 of the blind rivet nut 162 against the workpiece 166, as shown in FIG. 9. In the described embodiment, the third output shaft position is different than the second output shaft position. However, in other embodiments, the third output shaft position may be the same as the second output shaft position.

As the carrier 86 moves from the first carrier position to the second carrier position, the actuating arm 121 is pivoted to the actuating position via its arrangement in the groove 123 of the carrier 86. However, during the setting stroke, actuation of the limit switch 122 does not result in the first motor 26 being activated. Rather, the first motor 26 is maintained in a deactivated state to avoid rotating the output shaft 18 during the setting stroke.

When the carrier 86 reaches the second carrier position during the setting stroke, the magnet 150 in the cam member 138 is detected by the sensor 154, causing the second motor 30 to reverse its rotational direction. Thus, the cam member 138 is rotated clockwise as viewed in FIG. 3 about the rotation axis 142, causing the pin 146 to move within the recess 98 of the lobe 94 and thereby pull the lobe 94 toward from the front piece 46. The carrier 86 is thus moved in a forward direction towards the first carrier position FIG. 2.

Once the carrier 86 has returned to the first carrier position at which time the setting stroke has been completed, the operator may depress a reverse button 190 FIG. 1 to activate the first motor 26 and rotate the output shaft 130 in an unthreading direction that is opposite the threading direction. The output shaft 18 is also rotated in a reverse direction, thus beginning an unthreading action from the blind rivet nut 162. Specifically, as shown in FIG. 10, the output shaft 18 is caused to rotate in an unthreading direction 194 that is opposite the threading direction 184, thus unthreading the output shaft 18 from the threaded bore 178 of the now-set blind rivet nut 162. As the output shaft 18 unthreads from the blind rivet nut 162, the output shaft 18 also translates along the longitudinal axis 22 to return to the first output shaft position where the tool 10 is ready for a subsequent setting operation.

Various features of the invention are set forth in the following claims.

What is claimed is:

1. A method of operating a blind rivet nut-setting tool, the method comprising:
activating a first motor automatically in response to pressing a blind rivet nut coupled to an output shaft of the tool against a workpiece, thereby displacing the output shaft along a longitudinal axis from a first position, in which a limit switch is not engaged, to a second position, in which the limit switch is engaged, causing the first motor and the output shaft to rotate about the longitudinal axis relative to the blind rivet nut;
depressing a trigger to activate a second motor, causing the second motor and a cam member to rotate about a rotational axis and displace the output shaft along the longitudinal axis to a third position where the blind rivet nut becomes plastically deformed and permanently set on the workpiece; and
depressing a reverse trigger to activate the first motor and rotate the output shaft in an unthreading direction to unthread the blind rivet nut from the output shaft.

2. The method of claim 1, wherein the step of rotating the cam member includes causing a pin to move within a recess, which displaces a carrier from a first carrier position to a second carrier position.

3. The method of claim 2, further comprising, in response to the carrier being translated from the first carrier position to the second carrier position, detecting a magnet on the cam member with a sensor.

4. The method of claim 3, further comprising, in response to detecting the magnet with the sensor, activating the second motor to rotate the cam member to translate the carrier from the second carrier position to the first carrier position.

5. The method of claim 1, wherein the rotational axis is perpendicular to the longitudinal axis.

6. A method of operating a blind rivet nut-setting tool, the method comprising:
engaging a blind rivet nut with an output shaft of the tool with a sufficient force, causing the output shaft to move the output shaft in a rearward direction along a longitudinal axis from a first position to a second position;
activating a first motor to rotate the output shaft about the longitudinal axis in response to the output shaft reaching the second position, thereby coupling the blind rivet nut onto the output shaft and translating the output shaft toward the first position;
deactivating the first motor in response to the output shaft returning to the first position, at which point the blind rivet nut is engaged with a nosepiece of the tool; and
activating a second motor to translate the output shaft along the longitudinal axis toward a third position that is rearward of the first position, thereby crushing the blind rivet nut against the nosepiece.

7. The method of claim 6, further comprising activating the first motor to rotate the output shaft about the longitudinal axis to unthread the output shaft from the blind rivet nut after crushing the blind rivet nut against the nosepiece.

8. The method of claim 6, further comprising activating a limit switch in response to the step of applying the sufficient force to the output shaft to move the output shaft in the rearward direction along the longitudinal axis from the first position to the second position, wherein in response to the limit switch being activated, the step of the first motor being caused to rotate the output shaft about the longitudinal axis is automatically performed.

9. The method of claim 6, wherein the step of activating the second motor to translate the output shaft along the longitudinal axis to the third position that is rearward of the first position includes translating a carrier from a first carrier position to a second carrier position.

10. The method of claim 9, wherein the step of translating the carrier from the first carrier position to the second carrier position includes the second motor rotating a cam member about a rotational axis with a pin arranged in a lobe of the carrier.

11. The method of claim 10, wherein the rotational axis is perpendicular to the longitudinal axis.

12. The method of claim 10, further comprising, in response to the carrier being translated from the first carrier position to the second carrier position, detecting a magnet on the cam member with a sensor.

13. The method of claim 12, further comprising, in response to detecting the magnet with the sensor, activating the second motor to rotate the cam member to translate the carrier from the second carrier position to the first carrier position.
